(19) United States
(12) Patent Application Publication
(10) Pub. No.: US 2025/0195312 A1
(43) Pub. Date: Jun. 19, 2025

(54) AUTOMATIC BLOOD SUGAR LOWERING EXERCISE DEVICE

(71) Applicant: Chang Dae PARK, Seoul (KR)

(72) Inventor: Chang Dae PARK, Seoul (KR)

(21) Appl. No.: 19/064,644

(22) Filed: Feb. 26, 2025

Related U.S. Application Data
(63) Continuation of application No. PCT/KR2023/013437, filed on Sep. 7, 2023.

(30) Foreign Application Priority Data
Sep. 7, 2022 (KR) 10-2022-0113572

(51) Int. Cl. A61H 1/02

(52) U.S. Cl. CPC A61H 1/0244; A61H 2201/1215; A61H 2201/149; A61H 2201/1633; A61H 2201/1642; A61H 2201/1664; A61H 2201/5007; A61H 2203/0437; A61H 2230/203

(57) ABSTRACT

An automatic blood sugar lowering exercise device can effectively lower blood sugar levels of users, particularly diabetics who need to manage blood sugar levels, by consuming energy through automatic exercise in which a user repeatedly lifts and lowers both legs extended forward at a predetermined speed while the buttock is supported on a seat located at a predetermined height from the ground.

### TECHNICAL FIELD

The present invention relates to an automatic blood sugar lowering exercise device, and more specifically, to an automatic blood sugar lowering exercise device that may effectively lower blood sugar levels of users, particularly diabetics who need to manage blood sugar levels, by consuming energy through automatic exercise in which a user repeatedly lifts and lowers both legs extended forward at a predetermined speed while the buttock is supported on a seat located at a predetermined height from the ground.

### BACKGROUND ART

In order to maintain homeostasis of a human body, a blood sugar level has to be maintained within a certain range.

The blood sugar level of a human body is usually maintained at around 90 mg/dl due to an antagonistic action of hormones that contribute to maintaining the blood sugar level.

Diabetes occurs when a secretion of insulin, which lowers a blood sugar level, is abnormal, preventing the blood sugar level of the human body from being maintained at a constant level.

In order to treat such diabetes, drug treatment is important, but it is also important to continuously measure and manage a blood sugar level to prevent complications.

Therefore, management is required to measure the blood sugar level and maintain the blood sugar level at a certain level.

In order to measure and manage blood sugar levels, many technologies have been studied and proposed, and in the conventional art, “diabetes blood sugar information providing system and method” was proposed in Korean Patent Publication No. 10-2016-0007578 (published on Jan. 20, 2016).

The conventional art discloses technology for measuring a user's blood sugar level and providing blood sugar information, such as the user's insulin administration and food intake information.

However, the conventional art simply provides information on insulin administration and food intake for a user's blood sugar level management, and accordingly, there was a problem that a level of assistance in managing the user's blood sugar level was limited.

In another conventional art to solve the problem, a “blood sugar level management network system” was proposed in Korean Patent Publication No. 10-2018-0090076 (published on Aug. 10, 2018).

Another conventional art discloses technology regarding an exercise load provider that provides an exercise load to a user such that the user's blood sugar level may be controlled through exercise.

However, the exercise load provider according to another conventional art is a device that requires a user to actively move the body by his/her own will, such as a treadmill for running exercise or a cycle machine for cycling exercise, and accordingly, there is a disadvantage that it is not effective when the user does not exercise by himself/herself, and a large load is placed on the user's knees.

### DISCLOSURE

### Technical Problem

The present invention is provided to solve the problems of the conventional art, and an objective of the present invention is to provide an automatic blood sugar lowering exercise device that may effectively lower the blood sugar of a user, particularly, the blood sugar of a diabetic who needs to manage a blood sugar, by consuming energy through automatic exercise even when the user does not actively move the body by his/her own will.

### Technical Solution

In order to achieve the objective, an automatic blood sugar lowering exercise device according to the present invention includes a pair of leg holders configured to place two legs of a user stretched forward while a buttock of the user is supported on a seat located at a predetermined height from a ground; a lifting/lowering supporting stand configured to support the pair of leg holders to be lifted and lowered; a lifting/lowering drive unit configured to lift and lower the pair of leg holders by power; and an exercise control unit configured to control an operation of the lifting/lowering drive unit such that the pair of leg holders are repeatedly lifted and lowered at a predetermined speed for a predetermined period of time to reduce the user's blood sugar through an automatic exercise.

Here, the lifting/lowering supporting stand may include a base plate placed on the ground, a pair of guide rails erected to be separated from each other at a predetermined distance on the base plate, a lifting/lowering body supported by the pair of guide rails to be lifted and lowered and having female screw threads formed on an inner circumferential surface of a hollow extending upward and downward, and a connection bracket connecting the pair of leg holders to the lifting/lowering body such that the pair of leg holders is lifted and lowered integrally with the lifting/lowering body, and the lifting/lowering drive unit may include a ball screw having a predetermined vertical length, being supported by the pair of guide rails to be axially and rotatably, having male screw threads formed on an outer circumferential surface such that the lifting/lowering body is lifted and lowered according to a rotation direction, and ball-screw-coupled to the hollow of the lifting/lowering body, and a forward and reverse rotation motor configured to rotate the ball screw in a forward or reverse direction according to a control signal of the exercise control unit.

Here, in the lifting/lowering drive unit, a rotation axis of the forward and reverse rotation motor may be axially connected to an upper end of the ball screw by a connection coupler in a state where a body of the forward and reverse rotation motor is fixed to upper end portions of the pair of guide rails.

Here, the exercise control unit may control an operation of the lifting/lowering drive unit such that the pair of leg holders are alternately lifted and lowered in opposite directions.

Here, the exercise control unit may include a speed controller capable of adjusting lifting and lowering speeds of the pair of leg holders according to the user's manipulation.

Also, the automatic blood sugar lowering exercise device according to the present invention may further include a bio-signal measurement unit for measuring the user's bio-signals including a heart rate in real time; and a mode selection unit configured to select a measurement mode or an exercise mode and to input a maximum heart rate of the user or an age for estimating the maximum heart rate, wherein, when the measurement mode is selected by the mode selection unit, the exercise control unit may control an operation of the lifting/lowering drive unit such that the lifting and lowering speeds of the pair of leg holders gradually increase and decrease within a certain range, and when the exercise mode is selected by the mode selection unit, the exercise control unit may control the operation of the lifting and lowering drive unit such that the pair of leg holders are repeatedly lifted and lowered at a set basic speed, and a basic speed set in the exercise mode may be determined as a lifting and lowering speed when a heart rate measured by the bio-signal measurement unit of the user by using the measurement mode reaches 65% to 75% of the maximum heart rate input or estimated by the mode selection unit of the user.

Here, the bio-signal measurement unit may further include a blood sugar level in the user's bio-signal capable of being measured in real time, and when a blood sugar level measured by the bio-signal measurement unit reaches a set appropriate blood sugar level, the exercise control unit may notify the user or stop the operation of the lifting/lowering drive unit.

### Advantageous Effects

An automatic blood sugar lowering exercise device according to the present invention has an advantage in that blood sugar levels of users, particularly diabetics who need to manage blood sugar levels may be lowered by consuming energy through automatic exercise in which a user repeatedly lifts and lowers both legs extended forward at a predetermined speed while the buttock is supported on a seat located at a predetermined height from the ground

Also, the automatic blood sugar lowering exercise device according to the present invention has an advantage of being able to effectively lower blood sugar levels in a customized manner by determining a lifting/lowering speed in which a user may perform an exercise of medium intensity that is effective in lowering blood sugar levels through a measurement mode based on the user's heart rate and providing the lifting/lowering speed in an exercise mode.

Also, the automatic blood sugar lowering exercise device according to the present invention has an advantage of being able to efficiently use time and stably manage blood sugar by measuring a user's blood sugar level and notifying the user or stopping the automatic exercise when the set appropriate blood sugar level is reached during the automatic exercise.

### DESCRIPTION OF DRAWINGS

FIG. 1 is a perspective view of an automatic blood sugar lowering exercise device according to an embodiment of the present invention.

FIG. 2 is a configuration diagram of an automatic blood sugar lowering exercise device according to an embodiment of the present invention.

FIGS. 3A-3C illustrate frontal use state views of operation states of an automatic blood sugar lowering exercise device according to an embodiment of the present invention.

FIG. 4 is an enlarged perspective view of a main portion of an automatic blood sugar lowering exercise device according to an embodiment of the present invention.

FIG. 5 is a side view of an automatic blood sugar lowering exercise device according to an embodiment of the present invention.

FIG. 6 is a graph illustrating a change in glycated hemoglobin (%) according to exercise intensity.

### BEST MODE FOR INVENTION

An automatic blood sugar lowering exercise device according to the present invention includes a pair of leg holders configured to place two legs of a user stretched forward while a buttock of the user is supported on a seat located at a predetermined height from a ground; a lifting/lowering supporting stand configured to support the pair of leg holders to be lifted and lowered; a lifting/lowering drive unit configured to lift and lower the pair of leg holders by power; and an exercise control unit configured to control an operation of the lifting/lowering drive unit such that the pair of leg holders are repeatedly lifted and lowered at a predetermined speed for a predetermined period of time to reduce the user's blood sugar through an automatic exercise.

### MODE FOR INVENTION

Hereinafter, an automatic blood sugar lowering exercise device according to the present invention is described in more detail with reference to the embodiments illustrated in the drawings.

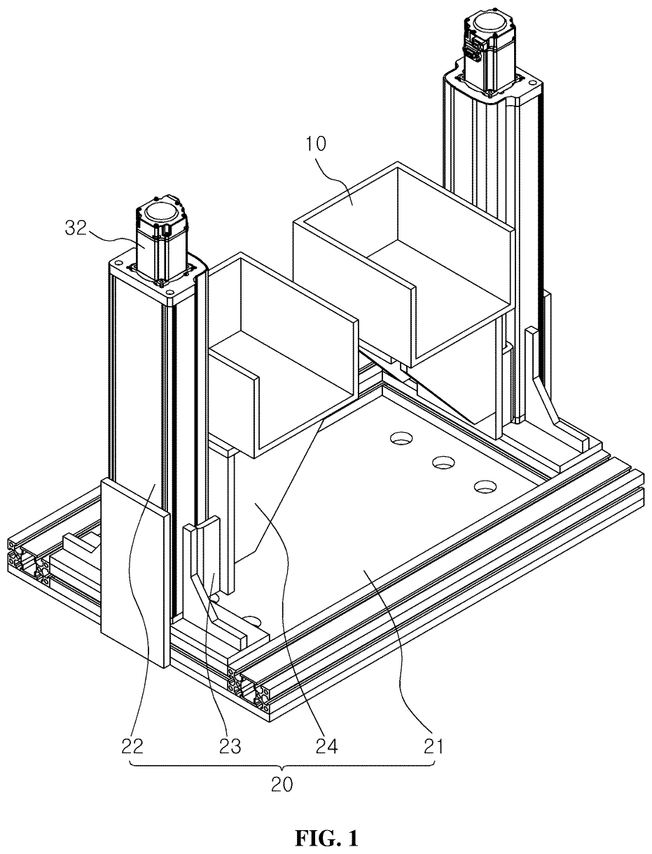

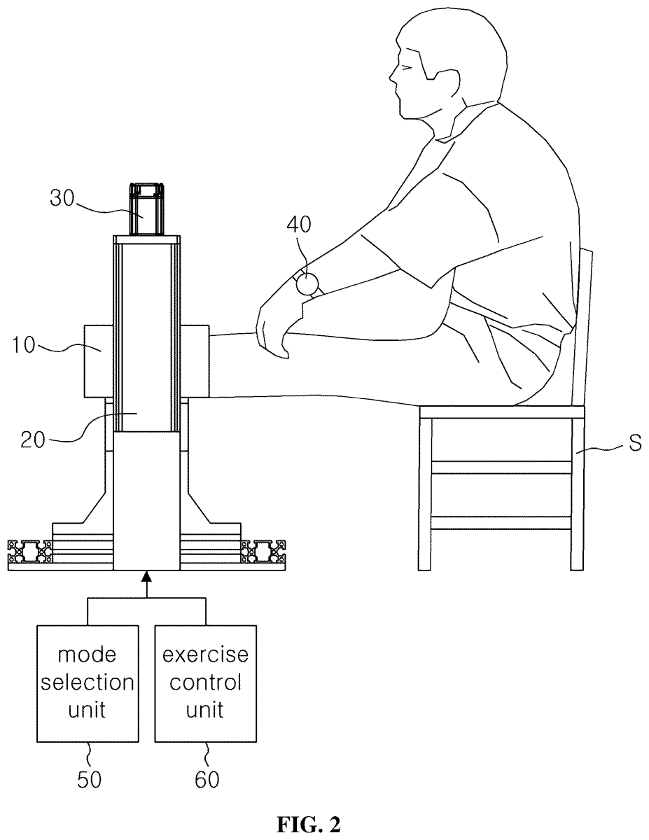

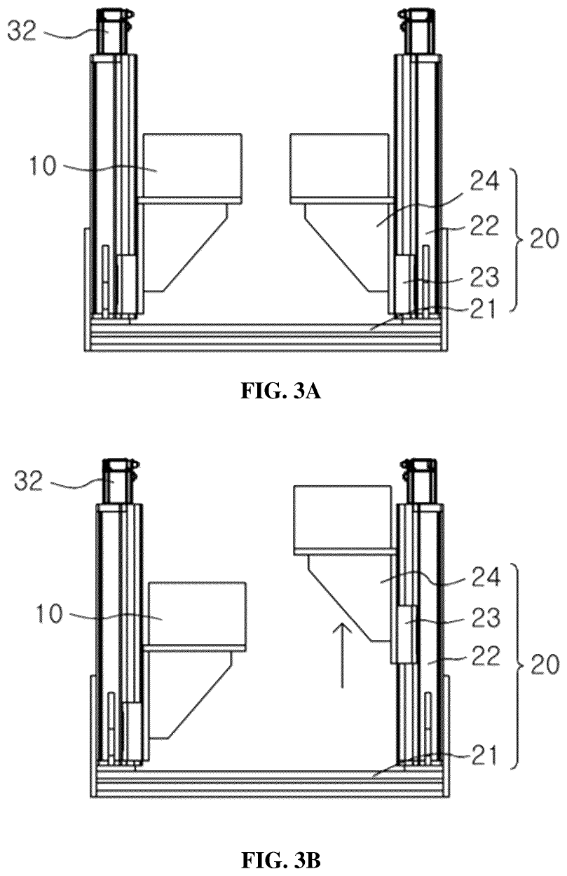

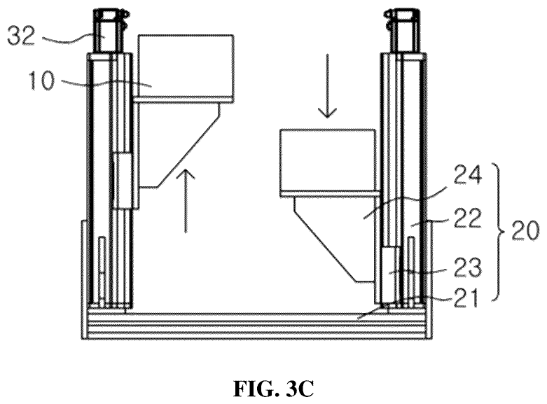

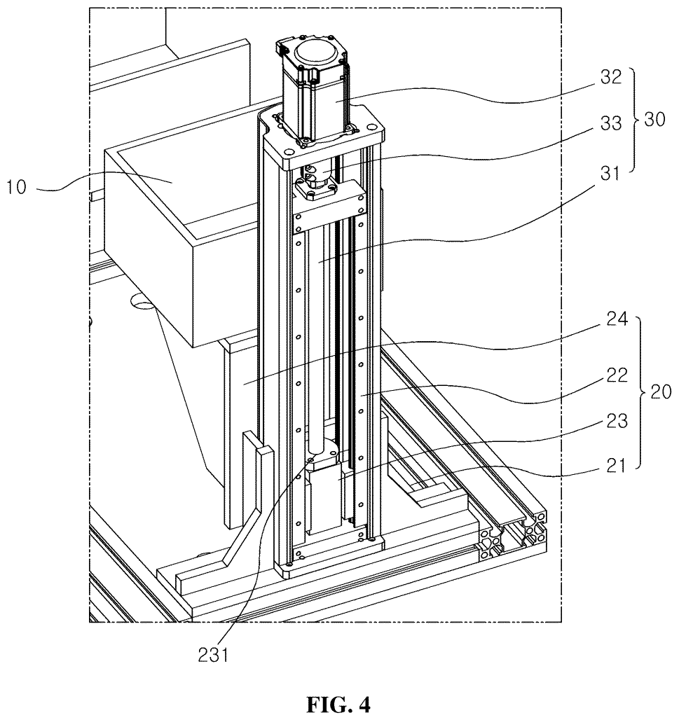

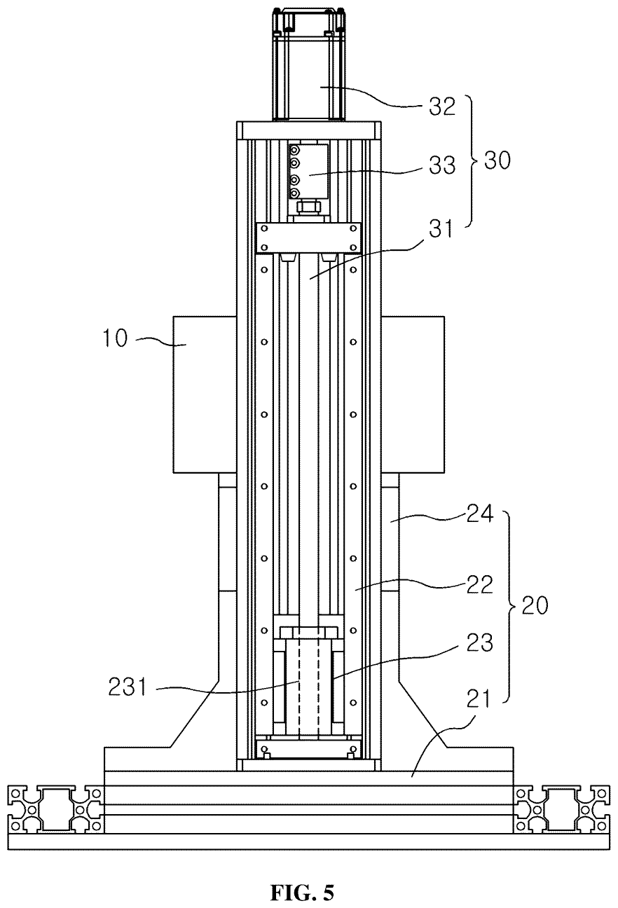

FIG. 1 is a perspective view of an automatic blood sugar lowering exercise device according to an embodiment of the present invention, FIG. 2 is a configuration diagram of the automatic blood sugar lowering exercise device according to the embodiment of the present invention, FIGS. 3A-3C illustrate frontal use state views of operation states of the automatic blood sugar lowering exercise device according to the embodiment of the present invention, FIG. 4 is an enlarged perspective view of a main portion of the automatic blood sugar lowering exercise device according to the embodiment of the present invention, and FIG. 5 is a side view of the automatic blood sugar lowering exercise device according to the embodiment of the present invention.

Referring to FIG. 2, the automatic blood sugar lowering exercise device according to the embodiment of the present invention includes a leg holder 10, a lifting/lowering supporting stand 20, a lifting/lowering drive unit 30, a bio-signal measurement unit 40, a mode selection unit 50, and an exercise control unit 60.

The leg holder 10 is provided as a pair and has a configuration in which a user may place both legs stretched forward while the buttock is supported on a seat S located at a certain height from the ground.

The seat S has a configuration in which the two legs stretched forward while the user's buttock is supported upward are located at a certain height from the ground such that the two legs may move up and down smoothly.

It is preferable that the seat S be configured as a chair of which height may be adjusted, such that a height of the seat S is adjusted to be equal to a height of the leg holder 10 in an initial state where a pair of leg holders 10 are mutually placed horizontally, as in FIG. 3A.

Also, the seat S may be configured such that a user may sit on an edge of a bed together, or the user may place both legs stretched forward while lying down, on the pair of leg holders 10.

The leg holder 10 may be formed in a drawer shape having an open inlet into which a leg may be inserted as illustrated in FIG. 1 such that the leg of a user placed thereon does not fall out, and may further include a fixing belt (not illustrated) that may fix the user's leg to the leg holder 10.

Meanwhile, the leg holder 10 may also be configured as a cast-shaped structure that may fix the user's leg in a forward-spread state.

The lifting/lowering supporting stand 20 has a configuration in which the pair of leg holders 10 is supported to be able to be lifted and lowered, and in one embodiment of the present invention, as illustrated in FIG. 3A to FIG. 5, the lifting/lowering supporting stand 20 includes a base plate 21, a guide rail 22, a lifting/lowering body 23, and a connection bracket 24.

The base plate 21 is configured to be placed on the ground in a rectangular plate shape such that the lifting/lowering supporting stand 20 may be stably supported on the ground.

The guide rail 22 is configured as a pair, and a pair of guide rails 22 are erected to be separated from each other on the base plate 21 at a certain distance from each other.

The guide rail 22 supports the lifting/lowering body 23 to be able to be lifted and lowered, and an upper portion thereof fixes a body of a forward and reverse rotation motor 32.

The lifting/lowering body 23 is supported to be able to be lifted and lowered by each of the pair of guide rails 22, and has a female screw thread formed on an inner circumferential surface of a hollow 231 that penetrates upward and downward.

That is, an outer shape of the lifting/lowering body 23 is a shape that is supported to be able to be lifted and lowered by the guide rail 22, and the hollow 231, through which a ball screw 31 passes upward and downward and which has a female screw thread to be coupled to the ball screw 31, is formed in a central portion of the lifting/lowering body 23.

The connection bracket 24 is configured to connect the leg holder 10 to the lifting/lowering body 23, and the leg holder 10 may be lifted and lowered integrally with the lifting/lowering body 23 by the connection bracket 24.

In one embodiment of the present invention, the connection bracket 24 is formed in a shape of a right-angled inverted triangle such that the leg holder 10 is fixed in a safe-placement state on an upper horizontal surface, and the lifting/lowering body 23 is connected to a side vertical surface, thereby having structural stability.

The lifting/lowering drive unit 30 has a configuration in which the pair of leg holders 10 may be lifted and lowered by power, and in one embodiment of the present invention, as illustrated in FIG. 4 and FIG. 5, the ball screw 31, a forward and reverse rotation motor 32, and a connection coupler 33 are provided.

The ball screw 31 has a certain vertical length and is supported to be axially and rotatably supported on the guide rail 22, and has a male screw thread formed on an outer circumferential surface such that the lifting/lowering body 23 may be lifted and lowered in a rotation direction, and is configured to be coupled with the ball screw 31 in the hollow 231 of the lifting/lowering body 23.

That is, the ball screw 31 is configured to convert a shaft rotation motion of the ball screw 31 into a linear motion of the lifting/lowering body 23 moving in a longitudinal direction of a shaft.

A ball screw refers to a screw of which steel ball is inserted into a spiral groove after a male screw and a female screw are aligned with each other, and the ball screw coupling described above is highly efficient and has low friction, and accordingly, heat occurs less, which enables low-noise and high-speed lifting and lowering of the lifting/lowering body 23.

The forward and reverse rotation motor 32 is configured to rotate the ball screw 31 in a positive or negative direction according to a control signal of the exercise control unit 60.

In one embodiment of the present invention, the forward and reverse rotation motor 32 is arranged such that a body thereof is fixed to an upper end portion of the lifting/lowering rail 23 and a rotation axis is directed downward in a straight line with an axial direction of the ball screw 31.

The connection coupler 33 is configured to mutually and axially connect the rotation axis of the forward and reverse rotation motor 32 to an upper end of the ball screw 31.

That is, the connection coupler 33 is configured to directly connect the ball screw 31 to the forward and reverse rotation motor 32, and through a combination of the configurations, the device according to the present invention has a simple appearance while enabling high-speed lifting and lowering of the lifting/lowering body 23.

Although a ball screw method is adopted as a driving method of the lifting/lowering drive unit 30 in one embodiment of the present invention, it is also possible to adopt a cylinder method of allowing a direct linear reciprocating motion, or a crank method of converting an eccentric rotational motion into a linear reciprocating motion by using a connection rod.

However, as the driving method of the lifting/lowering drive unit 30, the cylinder method, which has a disadvantage of being expensive, and the crank method has a disadvantage of being noisy, and accordingly, a ball screw method is preferable as the driving method of the lifting/lowering drive unit 30 as in one embodiment of the present invention.

The bio-signal measurement unit 40 is configured to be able to measure a user's bio-signals, which include a heart rate and a blood sugar level, in real time.

The bio-signal measurement unit 40 that measures the heart rate may use various wearable devices, such as a band type worn on the chest, a band type worn on the forearm, or a smart watch type worn on the wrist as illustrated in FIG. 2.

Meanwhile, the bio-signal measurement unit 40 for measuring blood sugar levels may be a continuous glucose meter (CGM) that may measure blood sugar levels by attaching a sensor onto an arm (upper arm) currently in use on the market, or a non-invasive glucometer having a form of a smartwatch, which may be worn on the wrist and is currently under technology development as illustrated in FIG. 2, may be used.

The mode selection unit 50 is configured to select a measurement mode or an exercise mode and to input a user's maximum heart rate or an age for estimating the maximum heart rate.

In a method of estimating the maximum heart rate from the user's input age, the maximum heart rate is usually obtained by subtracting the age from 220.

For example, when the user's age input to the mode selection unit 50 is 50, the user's maximum heart rate may be estimated as 170 which is obtained from an equation 220−50=170.

The exercise control unit 60 is configured to control an operation of the lifting/lowering drive unit 30 by repeatedly lifting and lowering the pair of leg holders 10 at a predetermined speed for a predetermined time such that a user's blood sugar level may be lowered through an automatic exercise.

It is preferable that a lifting/lowering height of the pair of leg holders 10 is about 20 cm to about 30 cm from an initial height.

Meanwhile, when a diabetic patient used a prototype of a device according to the present invention multiple times in a pattern of 10 minutes of exercise followed by 3 minutes of rest after a meal for an experiment, it was confirmed that an initial blood sugar level gradually decreased from the initial 200 to 160, 130, and 120 as the number of times increased.

In one embodiment of the present invention, the exercise control unit 60 controls an operation of the lifting/lowering drive unit 30 such that the pair of leg holders 10 are alternately lifted and lowered in opposite directions as illustrated in FIGS. 3A-3C.

With the configuration described above, a user automatically moves both legs up and down in opposite directions while stretching both legs forward, and thus, an exercise effect is effectively increased while maintaining a stable posture.

In particular, this operation is an operation that consumes a lot of energy without putting a load on the knees, thereby being adopted as an exercise operation performed in the blood sugar lowering exercise device according to the present invention.

Meanwhile, the exercise control unit 60 includes a speed controller (not illustrated) that may control lifting/lowering speeds of the pair of leg holders 10 according to a user's manipulation.

That is, the user may control an automatic exercise intensity by controlling a lifting/lowering speed of the pair of leg holders 10.

In addition, when the lifting/lowering speed of the pair of leg holders 10 is significantly lowered by a speed controller (not illustrated), the device according to the present invention may also be used as a rehabilitation medical device.

When the device according to the present invention is used as a rehabilitation medical device, a user may use the device according to the present invention while lying on a bed.

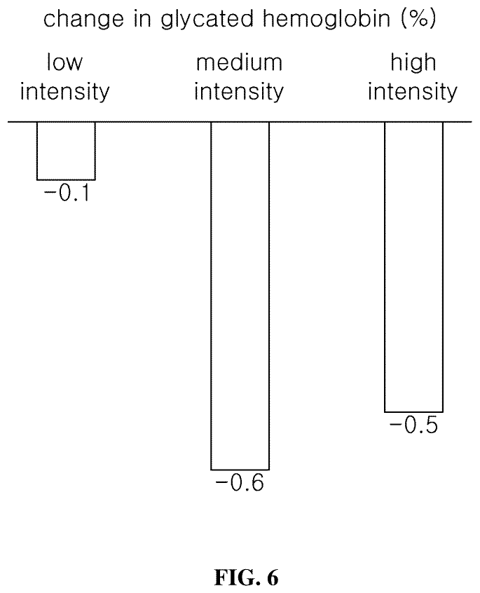

FIG. 6 illustrates a graph of a change in glycated hemoglobin (%) according to exercise intensity.

Glycated hemoglobin (HbAlc) refers to glycated Alc type hemoglobin, and the higher the blood sugar level, the more glycated hemoglobin is generated, the glycated hemoglobin is used to diagnose diabetes.

A normal range of the glycated hemoglobin is 4.0 to 6.0%, and when a glycated hemoglobin level is 6.5% or higher, diabetes may be diagnosed.

Referring to FIG. 6, it can be seen that an exercise of medium intensity is effective in lowering blood sugar from a change in glycated hemoglobin (%) according to exercise intensity.

Usually, the exercise of medium intensity refers to maintaining a heart rate of 65% to 75% of a user's maximum heart rate.

For example, when a user's maximum heart rate is 170, a heart rate of 70%, which is the intermediate value between 65% and 75%, is approximately 120, and accordingly, it can be said that an exercise intensity that maintains a user's heart rate at 120 is the most effective in lowering blood sugar.

Here, when a measurement mode is selected by the mode selection unit 50, the exercise control unit 60 controls an operation of the lifting/lowering drive unit 30 such that a lifting/lowering speed of the pair of leg holders 10 gradually increases and decreases within a certain range.

That is, the measurement mode is a mode for finding out a correlation between the lifting/lowering speed and exercise intensity customized for a user.

In addition, when the exercise mode is selected by the mode selection unit 50, the operation of the lifting/lowering drive unit 30 is controlled such that the pair of leg holders 10 repeatedly lifts and lowers at the set basic speed, and the basic speed set in the exercise mode is configured to be determined as the lifting/lowering speed when the heart rate measured by the bio-signal measurement unit 40 of a user by using the measurement mode reaches 65% to 75% of the maximum heart rate input to the mode selection unit 50 or estimated by the user.

With the configuration described above, a lifting/lowering speed is determined in which a user may perform an exercise of medium intensity that is effective in lowering blood sugar levels through a measurement mode based on the user's heart rate, the lifting/lowering speed is provided in an exercise mode, and thus, it is possible to effectively lower blood sugar levels in a customized manner.

In addition, the exercise control unit 60 according to an embodiment of the present invention is configured to notify a user or to stop an operation of the lifting/lowering drive unit 30 when the blood sugar level measured by the bio-signal measurement unit 40 reaches a set appropriate blood sugar level.

With the configuration described above, a user may stably manage blood sugar levels while optimizing the time required for an automatic exercise for lowering the blood sugar levels.

The automatic blood sugar lowering exercise device described above and illustrated in the drawings is only one embodiment for implementing the present invention and should not be construed as limiting the technical idea of the present invention. The protection scope of the present invention is determined only by the matters described in the following patent claims, and embodiments that are improved and modified without departing from the gist of the present invention are considered to fall within the protection scope of the present invention as long as the embodiments are obvious to a person having ordinary knowledge in the technical field to which the present invention belongs.

1. An automatic blood sugar lowering exercise device comprising:
a seat configured to support a buttock of a user at a predetermined height from a ground;
a pair of leg holders configured to place two legs of the user stretched forward while the buttock is supported on the seat;
a lifting/lowering supporting stand configured to support the pair of leg holders to be lifted or lowered;
a pair of lifting/lowering drivers, each of the pair of lifting/lowering drivers configured to lift or lower each of the pair of leg holders by power; and
an exercise controller configured to control an operation of the pair of lifting/lowering drivers such that the pair of leg holders are repeatedly lifted or lowered at a predetermined speed for a predetermined period of time to reduce the user's blood sugar through an automatic exercise.

2. The automatic blood sugar lowering exercise device of claim 1,
wherein the lifting/lowering supporting stand comprises:
a base plate placed on the ground;
a pair of guide rails erected to be separated from each other at a predetermined distance on the base plate;
a pair of lifting/lowering bodies, each of the pair of lifting/lowering bodies including a hollow therein and supported by each of the pair of guide rails to be lifted or lowered and having a female screw thread disposed on an inner circumferential surface of the hollow extending upward and downward; and
a pair of connection brackets, each of the pair of connection brackets connecting each of the pair of leg holders to each of the pair of lifting/lowering bodies such that each of the pair of leg holders is lifted or lowered integrally with each of the pair of lifting/lowering bodies, and
wherein each of the pair of lifting/lowering drivers comprises:
a ball screw having a predetermined vertical length, being supported by each of the pair of guide rails to be axially and rotatably, having a male screw thread disposed on an outer circumferential surface thereof such that each of the pair of lifting/lowering bodies is lifted or lowered according to a rotation direction, and ball-screw-coupled to the hollow of each of the pair of lifting/lowering bodies; and
a forward and reverse rotation motor configured to rotate the ball screw in a forward or reverse direction according to a control signal of the exercise controller.

3. The automatic blood sugar lowering exercise device of claim 2, wherein,
in each of the pair of lifting/lowering drivers, a rotation axis of the forward and reverse rotation motor is axially connected to an upper end of the ball screw by a connection coupler in a state where a body of the forward and reverse rotation motor is fixed to upper end portions of each of the pair of guide rails.

4. The automatic blood sugar lowering exercise device according to claim 1,
wherein
the exercise controller controls the operation of the pair of lifting/lowering drivers such that the pair of leg holders are alternately lifted or lowered in opposite directions.

5. The automatic blood sugar lowering exercise device according to claim 1,
wherein
the exercise controller includes a speed controller for adjusting lifting and lowering speeds of the pair of leg holders according to the user's manipulation.

6. The automatic blood sugar lowering exercise device according to claim 1, further comprising:
a bio-signal measurement unit for measuring the user's bio-signals including a heart rate in real time; and
a mode selector configured to select a measurement mode or an exercise mode and to input a maximum heart rate of the user or an age for estimating the maximum heart rate,
wherein, when the measurement mode is selected by the mode selector, the exercise controller controls the operation of the pair of lifting/lowering drivers such that the lifting and lowering speeds of the pair of leg holders increase or decrease within a range, and when the exercise mode is selected by the mode selector, the exercise controller controls the operation of the pair of lifting/lowering drivers such that the pair of leg holders are repeatedly lifted or lowered at a set speed, and
wherein the set speed in the exercise mode is determined as a lifting and lowering speed when a heart rate of the user measured by the bio-signal measurement unit during the measurement mode reaches 65% to 75% of the maximum heart rate input by the user or estimated by the mode selector.

7. The automatic blood sugar lowering exercise device of claim 6, wherein
the bio-signal measurement unit is further configured to measure a blood sugar level of the user in real time, and
when the blood sugar level measured by the bio-signal measurement unit reaches a set blood sugar level, the exercise controller notifies the user or stops the operation of the lifting/lowering driver.
